(19) United States
(12) Patent Application Publication
(10) Pub. No.: US 2014/0361655 A1
(43) Pub. Date: Dec. 11, 2014

(54) BRUSHLESS PERMANENT-MAGNET MOTOR

(71) Applicant: DURQ MACHINERY CORP., Taichung City (TW)

(72) Inventors: Chia-Sheng LIU, Taichung City (TW); Yi-Li ZHENG, Taichung City (TW)

(73) Assignee: DURQ MACHINERY CORP., Taichung City (TW)

(21) Appl. No.: 13/963,871

(22) Filed: Aug. 9, 2013

(30) Foreign Application Priority Data
Jun. 7, 2013 (TW) 102120401

(51) Int. Cl. H02K 1/27

(52) U.S. Cl. CPC H02K 1/278
USPC 310/156.12

(57) ABSTRACT

A brushless permanent-magnet motor includes a stator, a rotor rotatably mounted within the stator in a coaxial manner, a magnet set including a plurality of magnet components mounted around the periphery of the rotor and leaving a gap between the magnet set and the stator, and two locating plates made from a magnetically conductive material and respectively mounted at two opposite sides of the rotor for synchronous rotation with the magnet set and the rotor. Thus, the brushless permanent-magnet motor has a high level of structural stability, and can effectively improve the air-gap flux density and electromagnetic torque under the rated revolving speed to further enhance the performance of the motor.

### BACKGROUND OF THE INVENTION

1. Field of the Invention

The present invention relates to brushless motor technology, and more particularly to a brushless permanent-magnet motor, which uses two magnetically conductive locating plates to secure magnet components to the rotor, enhancing the structural stability and effectively improving the air-gap flux density and the electromagnetic torque at the rated speed so as to further enhance the performance of the motor.

2. Description of the Related Art

When compared to conventional motors, a brushless permanent-magnet motor has the benefits of high performance and high torque density, and therefore brushless permanent-magnet motors are widely used in different driving systems, such as marine propeller, lawn mower, elevator traction machine, etc. A conventional brushless permanent-magnet motor 5, as shown in FIG. 1, generally comprises a stator 51, a plurality of magnet components 52, and a rotor 53. The stator 51 comprises a plurality of teeth 54 spaced around the inner perimeter thereof, and a plurality of winding grooves 55 respectively defined between each two adjacent teeth for enabling a winding to be wound on the teeth 54. The magnet components 52 are reversely mounted around the periphery of the rotor 53 and abutted against one another, leaving a gap between the magnet components 52 and the teeth 54 of the stator 51. Thus, when a DC current is conducted to the winding, a rotating magnetic field is generated corresponding to each magnet component 52 at the rotor 53, causing the rotor 53 to rotate.

However, during operation of the brushless permanent-magnet motor 50 to convert electrical energy to kinetic energy, heat will be produced, causing deterioration of the adhesive between the outer perimeter of the rotor 53 and the magnet components 52, and the magnet components 52 can be forced away from the rotor 53 after a long use of the brushless permanent-magnet motor 50 due to the effect of centrifugal force upon a high speed rotation, leading to brushless permanent-magnet motor failure. Further, there is a small gap between each two adjacent teeth 54 of the stator 51 of the brushless permanent-magnet motor 50. When a DC current is conducted to the winding to create a rotating magnetic field, the magnetic flux density in the gap between each two adjacent teeth will be higher than that at the side of each tooth that faces toward the respective magnet component. Thus, when the longitudinal section of the connection between each two adjacent magnet component passes through the gap between the respective two adjacent teeth, the magnetic flux of the rotor 53 cannot be evenly guided to the stator 51, lowering the air-gap flux density and the performance of the motor.

In conclusion, the prior art structures still have drawbacks of low air-gap flux density and low performance, leaving room for improvement.

### SUMMARY OF THE INVENTION

The present invention has been accomplished under the circumstances in view. It is the main object of the present invention to provide a brushless permanent-magnet motor, which has a high level of structural stability, and can effectively improve the air gap flux density and the electromagnetic torque at the rated speed, thereby relatively enhancing the performance of the motor.

To achieve this and other objects of the present invention, a brushless permanent-magnet motor of the invention comprises a stator, a rotor, a magnet set, and two locating plates. The rotor is rotatably mounted within the stator in a coaxial manner relative to the stator. The magnet set comprises a plurality of magnet components mounted around the periphery of the rotor and leaving a gap between the magnet set and the stator. The locating plates are made from a magnetically conductive material and respectively mounted at two opposite sides of the rotor for synchronous rotation with the magnet set and the rotor.

Preferably, the rotor comprises a plurality of through holes extending through the two opposite sides of said rotor; each locating plate comprises a plurality of mounting holes respectively disposed corresponding to the through holes of the rotor and respectively fixedly connected to the through holes of the rotor for enabling each locating plate to be rotated with the rotor synchronously.

Preferably, the through holes and the mounting holes are equiangularly spaced around the central axis of the rotor.

Preferably, each locating plate comprises an outer perimeter and a plurality of mounting grooves spaced around the outer perimeter for the mounting of the magnetic components respectively.

Preferably, each mounting groove defines a first accommodation space and a second accommodation space arranged in direction from the rotor toward the stator. Further, the volume of the first accommodation space is larger than the volume of the second accommodation space.

Preferably, each magnet component comprises an outer arc surface, an opposing inner arc surface, two opposing lateral sides and a flange located at each lateral side adjacent to the inner arc surface. The flanges of each magnet component is mounted in the first accommodation space and second accommodation space of one respective mounting groove of each locating plate.

Preferably, the rotor comprises a plurality of passages located at and spaced around the periphery of the rotor in a coaxial manner relative to the rotor.

Preferably, the passages of the rotor are equiangularly spaced around the central axis of the rotor.

Preferably, the stator comprises an inner perimeter, a plurality of teeth, a plurality of teeth spaced around the inner perimeter, and a winding groove defined between each two adjacent teeth for enabling a winding to be wound on each tooth and positioned in each winding groove. Each tooth comprises a front end portion disposed remote from the inner perimeter.

Thus, the invention uses the locating plates to secure the magnet components firmly to the rotor, preventing separation of the magnet components from the rotor due to deterioration of adhesive and the effect of a centrifugal force during a high speed rotation. Further, the locating plates are magnetically conductive members capable of guiding the magnetic flux of the rotor evenly to the stator to improve the air gap flux density and the electromagnetic torque at the rated speed and to further enhance the performance of the motor.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic sectional view of a brushless permanent-magnet motor according to the prior art.

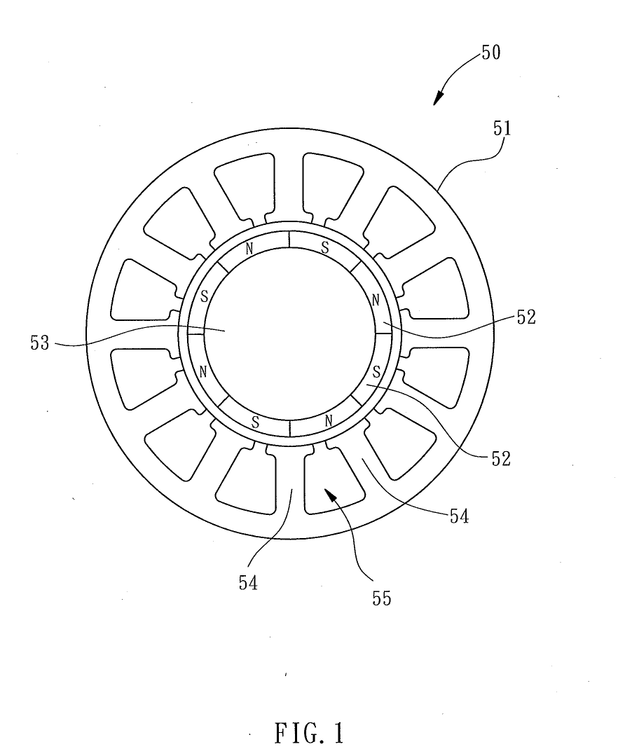

FIG. 2 is a schematic sectional view of a brushless permanent-magnet motor in accordance with a first embodiment of the present invention, illustrating the relative positioning of respective components.

FIG. 3 is an exploded view of the brushless permanent-magnet motor in accordance with the first embodiment of the present invention.

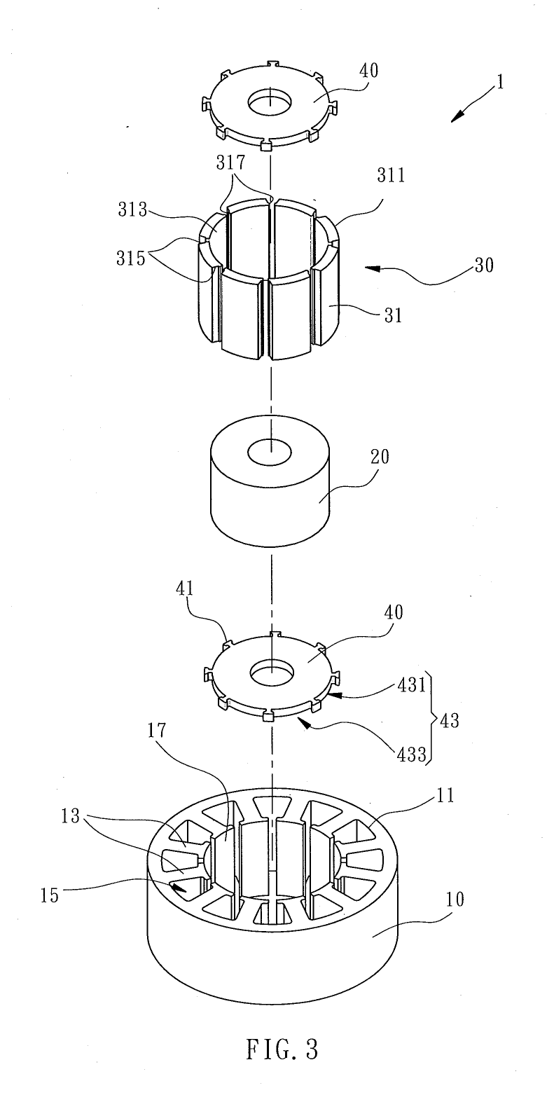

FIG. 4 is a schematic sectional view of a brushless permanent-magnet motor in accordance with a second embodiment of the present invention, illustrating the relative positioning of respective components.

FIG. 5 is an exploded view of the brushless permanent-magnet motor in accordance with the second embodiment of the present invention.

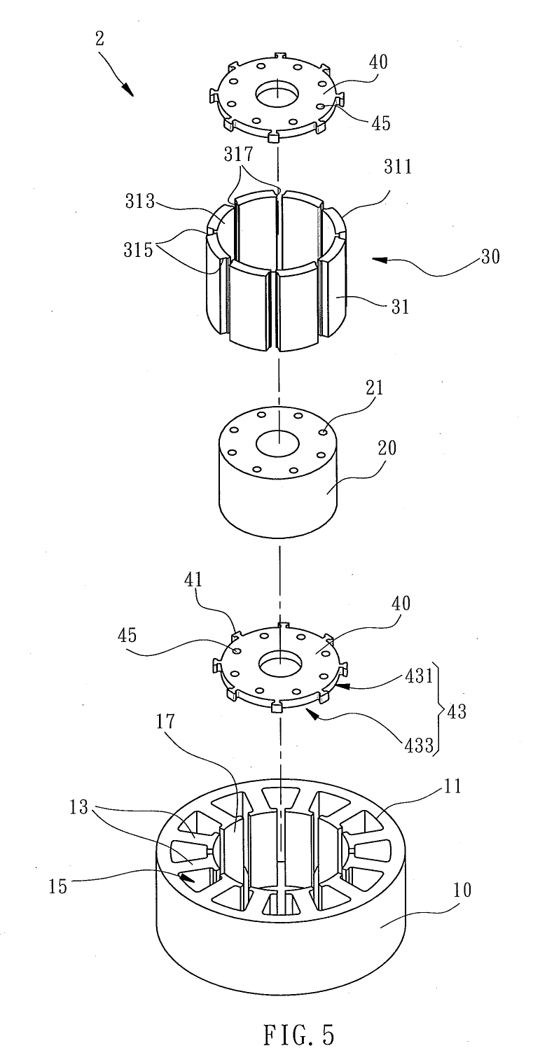

FIG. 6 is a schematic sectional view of a brushless permanent-magnet motor in accordance with a third embodiment of the present invention, illustrating the relative positioning of respective components.

FIG. 7 is an exploded view of the brushless permanent-magnet motor in accordance with the third embodiment of the present invention.

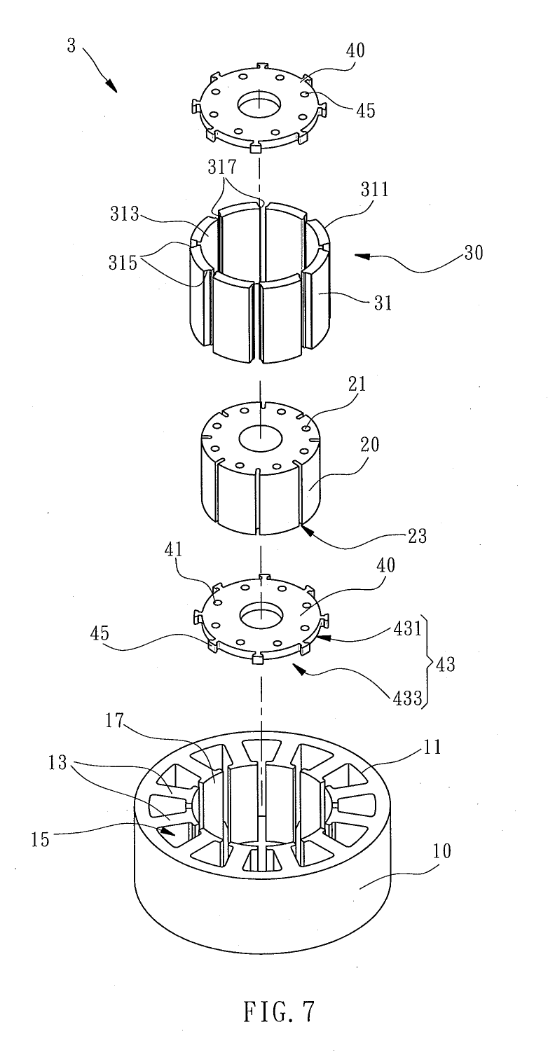

FIG. 8 is an air-gap flux density curve comparison chart obtained from the first, second and third embodiments of the invention.

FIG. 9 is an electromagnetic torque curve comparison chart obtained from the brushless permanent-magnet motors of the first, second and third embodiments of the invention at the rated speed.

### DETAILED DESCRIPTION OF THE INVENTION

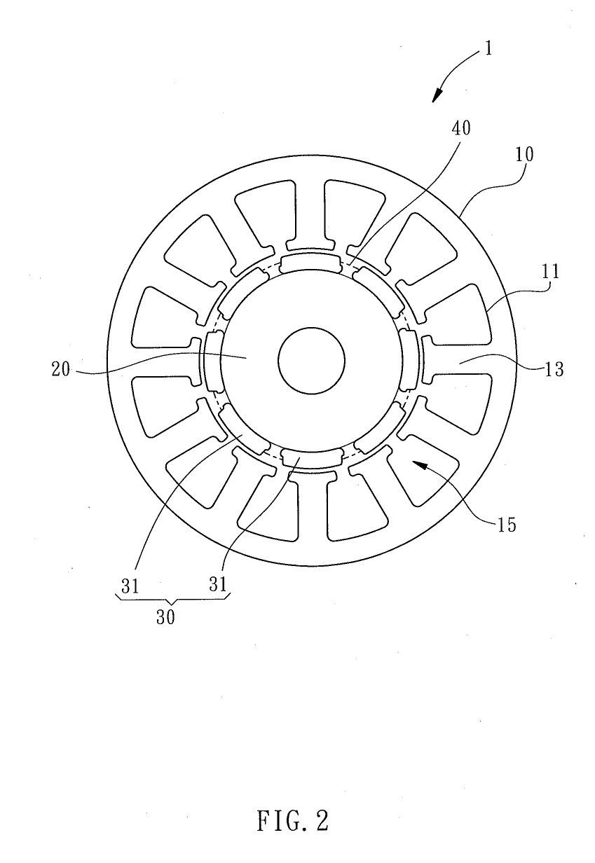

Referring to FIG. 2, a brushless permanent-magnet motor 1 in accordance with a first embodiment of the present invention is shown. The brushless permanent-magnet motor 1 comprises a stator 10, a rotor 20, a magnet set 30, and two locating plates 40.

The stator 10 comprises an inner perimeter 11, a plurality of teeth 13 spaced around the inner perimeter 11, and a winding groove 15 defined between each two adjacent teeth 13 for enabling a winding to be wound on each tooth 13 and positioned in each winding groove 15. Each tooth 13 has a front end portion 17 disposed remote from the inner perimeter 11.

The rotor 20 is rotatably disposed within the stator 10 in a coaxial manner relative to the stator 10.

The magnet set 30 comprises a plurality of magnet components 31. Each magnet component 31 comprises an outer arc surface 311, an opposing inner arc surface 313, and two opposing lateral sides 315. The inner arc surfaces 313 of the magnet components 31 are respectively attached to and spaced around the periphery of the rotor 20 in such a manner that a gap is defined between the outer arc surfaces 311 of the magnet components 31 and the front end portions 17 of the teeth 13 of the stator 10. Each magnet component 31 further comprises a flange 317 located at each lateral side 315 adjacent to the inner arc surface 313.

The locating plates 40 are made from a magnetically conductive material and respectively fixedly mounted at opposing top and bottom sides of the rotor 20 for synchronous rotation with the magnet set 30 and the rotor 20. Each locating plate 40 comprises an outer perimeter 41, and a plurality of mounting grooves 43 spaced around the outer perimeter 41 for the mounting of the magnet components 31. Each mounting groove 43 defines a first accommodation space 431 and a second accommodation space 433 arranged in direction from the rotor 20 toward the stator 10. The volume of the first accommodation space 431 is larger than the volume of the second accommodation space 433. Thus, by means of the flanges 317, the magnet components 31 can be mounted in the first accommodation space 431 and second accommodation spaces 433 of the respective mounting grooves 43. Subject to the mounting structure between the rotor 20 and magnet set 30 and the locating plates 40 eliminates the problem of using an adhesive to bond the inner arc surfaces 313 of the magnet components 31 of the magnet set 30 to the outer perimeter of the rotor 20 that the applied adhesive will have deteriorated from heat due to energy loss during energy transformation, causing the magnet components 31 to drop from the rotor 30 due to the effect of centrifugal force upon a high speed rotation and leading to brushless permanent-magnet motor failure.

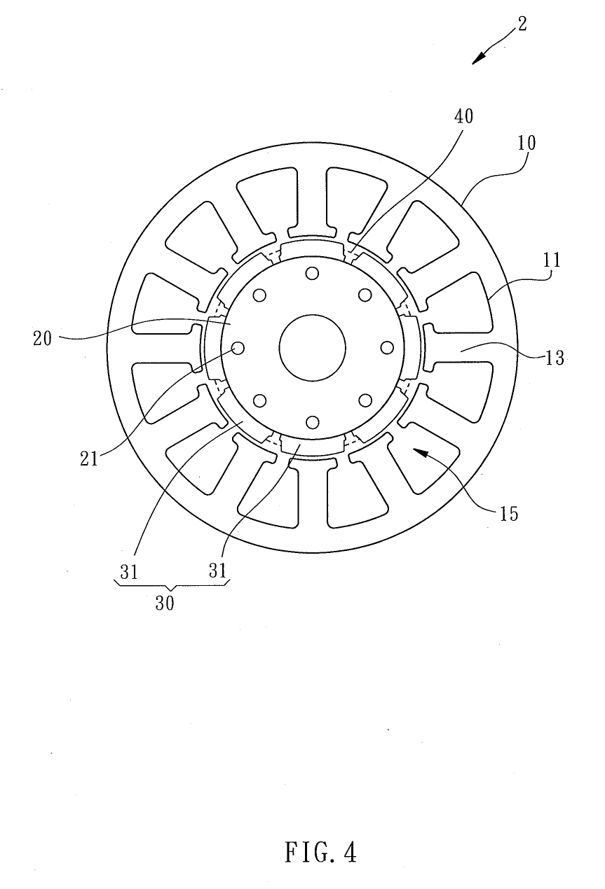

Referring to FIG. 4, a brushless permanent-magnet motor 2 in accordance with a second embodiment of the present invention is shown. This second embodiment is substantially similar to the aforesaid first embodiment with the exception that the rotor 20 comprises a plurality of through holes 21 extending through opposing top and bottom sides thereof; each locating plate 40 comprises a plurality of mounting holes 45 corresponding to the through holes 21 and respectively riveted to the through holes 21. Thus, the locating plates 40 can be synchronously rotated with the rotor 20. Further, the through holes 21 and the mounting holes 45 are equiangularly spaced around the central axis of the rotor 20. Relative positioning between the through holes 21 and the mounting holes 45 for synchronous rotation enhances the structural strength of the rotor 20, and can form a magnetic circuit breaker, enabling the magnetic flux density to be concentrated.

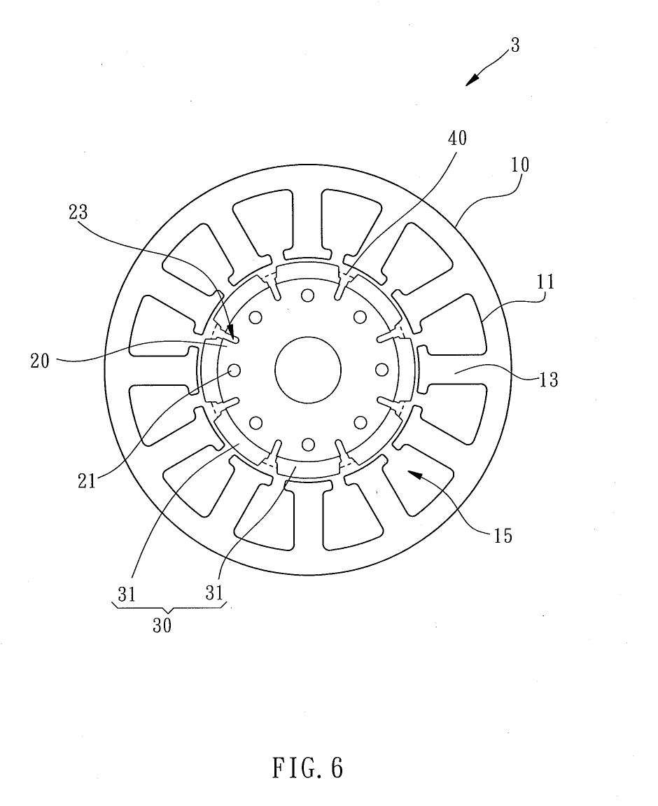

Referring to FIG. 6, a brushless permanent-magnet motor 2 in accordance with a third embodiment of the present invention is shown. This third embodiment is substantially similar to the aforesaid first and second embodiments with the exception that the rotor 20 comprises a plurality of passages 23 coaxially located at the periphery of the rotor 20 and equiangularly spaced around the central axis of the rotor 20, enhancing the performance of the motor 3.

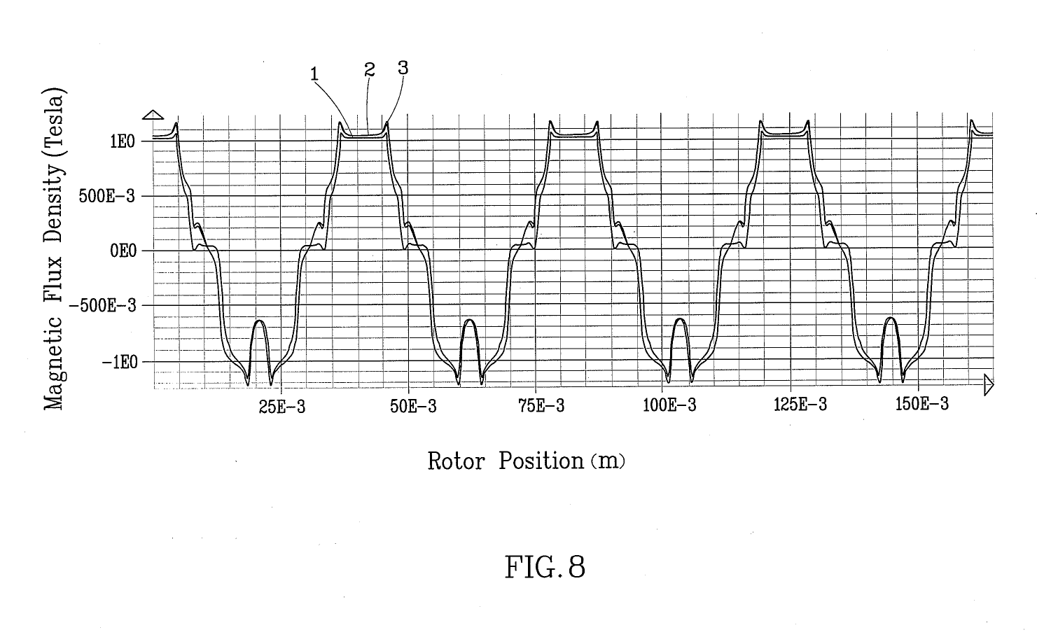

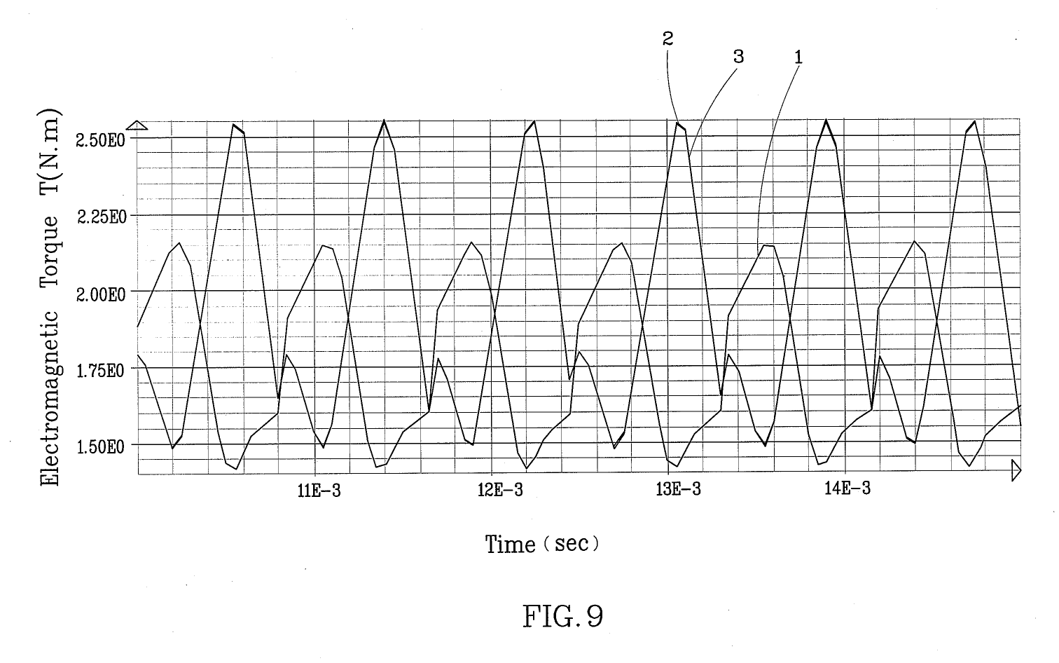

In order to more clearly state the effect of the present invention, comparison charts of the brushless permanent-magnet motors 1, 2, 3 of the aforesaid three different embodiments of the invention are illustrated. As illustrated in FIG. 8, according to the air-gap flux density curve comparison chart obtained from the first, second and third embodiments of the invention, the air-gap flux densities obtained from the brushless permanent-magnet motors 1, 2, 3 of the first, second and third embodiments are 0.7649 Tesla, 0.7952 Tesla and 0.8002 Tesla respectively. More particularly in the application of the first and second embodiments, the curves rise and fall in a conical manner. FIG. 9 is an electromagnetic torque curve comparison chart obtained from the brushless permanent-magnet motors 1, 2, 3 of the aforesaid three different embodiments of the invention at the rated revolving speed. As illustrated, the average electromagnetic torques obtained from the brushless permanent-magnet motors 1, 2, 3 of the first, second and third embodiments are 1.769 N-m, 1.9419 N-m and 1.9411 N-m respectively. In general, subject to the magnetic guide of the locating plates 40, the magnetic flux of the rotor 20 can be evenly guided to the stator 10 to improve the air-gap flux density and the electromagnetic torque at the rated speed, thereby relatively enhancing the performance of the motor.

In general, the brushless permanent-magnet motor of the present invention has the advantages and features as follows:

1. Subject to the design of the mounting grooves 43 of the locating plates 40 for the mounting of the magnet components 31, the invention prevents separation of the magnet components 31 from the rotor 20 to cause further brushless permanent-magnet motor failure due to a high temperature and high revolving speed environment.

2. The locating plates 40 are magnetically conductive members capable of guiding the magnetic flux of the rotor 20 evenly to the stator 10 to improve the air gap flux density and the electromagnetic torque at the rated speed and to further enhance the performance of the motor.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A brushless permanent-magnet motor, comprising:
a stator;
a rotor rotatably mounted within said stator in a coaxial manner relative to said stator;
a magnet set comprising a plurality of magnet components mounted around the periphery of said rotor and leaving a gap between said magnet set and said stator; and
two locating plates made from a magnetically conductive material and respectively mounted at two opposite sides of said rotor for synchronous rotation with said magnet set and said rotor.

2. The brushless permanent-magnet motor as claimed in claim 1, wherein said rotor comprises a plurality of through holes extending through the two opposite sides of said rotor; each said locating plate comprises a plurality of mounting holes respectively disposed corresponding to said through holes of said rotor and respectively fixedly connected to said through holes of said rotor for enabling each said locating plate to be rotated with said rotor synchronously.

3. The brushless permanent-magnet motor as claimed in claim 2, wherein said through holes and said mounting holes are equiangularly spaced around the central axis of said rotor.

4. The brushless permanent-magnet motor as claimed in claim 1, wherein each said locating plate comprises an outer perimeter and a plurality of mounting grooves spaced around said outer perimeter for the mounting of said magnetic components respectively.

5. The brushless permanent-magnet motor as claimed in claim 4, wherein each said mounting groove defines a first accommodation space and a second accommodation space arranged in direction from said rotor toward said stator, the volume of said first accommodation space being larger than the volume of said second accommodation space.

6. The brushless permanent-magnet motor as claimed in claim 5, wherein each said magnet component comprises an outer arc surface, an opposing inner arc surface, two opposing lateral sides and a flange located at each said lateral side adjacent to said inner arc surface, the flanges of each said magnet component being mounted in the first accommodation space and second accommodation space of one respective said mounting groove of each said locating plate.

7. The brushless permanent-magnet motor as claimed in claims 4, wherein said rotor comprises a plurality of passages located at and spaced around the periphery of said rotor in a coaxial manner relative to said rotor.

8. The brushless permanent-magnet motor as claimed in claims 1, wherein said rotor comprises a plurality of passages located at and spaced around the periphery of said rotor in a coaxial manner relative to said rotor.

9. The brushless permanent-magnet motor as claimed in claim 8, wherein said passages are equiangularly spaced around the central axis of said rotor.

10. The brushless permanent-magnet motor as claimed in claim 1, wherein said stator comprises an inner perimeter, a plurality of teeth, a plurality of teeth spaced around said inner perimeter, and a winding groove defined between each two adjacent said teeth for enabling a winding to be wound on each said tooth and positioned in each said winding groove, each said tooth comprising a front end portion disposed remote from said inner perimeter.
